(19) United States
(12) Patent Application Publication
(10) Pub. No.: US 2022/0117850 A1
(43) Pub. Date: Apr. 21, 2022

(54) A Tablet Dispensing Device

(71) Applicant: AIRNOV, INC., Wilmington, DE (US)

(72) Inventors: Bernardo Romeo, Paris (FR); Dominique Bois, Montreuil aux Lions (FR); Jacquy Lebon, Challans (FR)

(21) Appl. No.: 17/418,638

(22) PCT Filed: Dec. 27, 2019
(86) PCT No.: PCT/IB2019/061392

§ 371 Date: Jun. 25, 2021

(30) Foreign Application Priority Data
Dec. 27, 2018 (EP) 18306851.9

(51) Int. Cl. A61J 7/00; B65D 83/04; B65D 51/24

(52) U.S. Cl. CPC A61J 7/0076; B65D 83/0418; B65D 2583/0481; B65D 2583/0431; B65D 51/244

(57) ABSTRACT

A tablet dispensing device, comprising: a tubular container body including two extremities, a tubular side wall in between, the tubular side wall defining an internal dispensing space capable of receiving a tablet to be dispensed, and a tablet dispensing opening formed on the tubular side wall; a sleeve configured to slide longitudinally over the tubular side wall and between the two extremities, between a first position, in which the sleeve covers in an airtight manner the tablet dispensing opening, and a second position, in which the sleeve uncovers the tablet dispensing opening. This device is an improved device for the distribution of tablets.

### TECHNICAL FIELD

The present invention relates to a tablet dispensing device for the distribution of tablets, and a kit comprising one or more tablet dispensing devices. The present invention also relates to the use of the tablet dispensing device for the distribution of pharmaceutical, nutraceutical, veterinary and/or agro-alimentary products.

### TECHNICAL BACKGROUND

Over the years, the dispensing of tablets and pills has received increased attention in order to facilitate the tablet distribution as well as the user's manipulations.

Document EP 0 699 595 A1 describes a tubular container for holding tablets, the tubular container comprising a dispensing opening on its side wall. The location and dimension of the dispensing opening allows to dispense the contained tablets one by one without the user touching directly the tablet with his/her fingers.

Document U.S. Pat. No. 3,471,056 relates to a pill dispensing device including a hollow casing having a transverse pill discharge opening adjacent to one of its ends, and an escapement finger associated with said casing which makes it possible to discharge individual pills from the discharge opening, while trapping the remainder of the pills within the hollow casing.

Document US 2010/0294791 relates to a dispensing device for dispensing tablets belonging to a stack of tablets. The dispensing device comprises a conveying element arranged in a casing, the conveying element moving, in relation to said casing, between a dispensing and a conveying position.

Document FR 1,549,574 A describes a dispensing device for products such as candy, pills and tablets which makes it possible to avoid direct contact with the product. The dispensing device comprises a tubular body closed at one extremity and comprising a dispensing opening proximal to the other extremity, and a dispensing closure comprising an opening and a flexible strip. When pressure is provided to the dispensing closure, the flexible strip is moved towards the first tablet pushing it outwards while at the same time the dispensing opening and the opening of the dispensing closure become aligned.

Document U.S. Pat. No. 4,053,242 relates to a hand-held T-shaped disposable product applicator and a dispensing package. The applicator comprises a pad portion and a grip portion, the pad portion being foldable along its juncture with the grip portion. The dispensing package is adapted to receive a stack of applicators and comprises a dispensing opening through which the grip portion of the applicator is exposed for removal.

Document DE 31 43 953 A1 describes a dispenser for tablet-shaped products, comprising a storage container for tablets, a base element able to fasten the lower opening of the storage container and a dispensing slide moving translationally in order to distribute tablets while avoiding direct contact of the tablets with the user.

There is still a need for a tablet dispensing device which is easy to fabricate, easy to assemble and easy to handle, notably with one hand, and makes it possible to distribute tablets one-by-one and avoid contact of the tablet with the user as well as external contamination of the tablets. Furthermore, there is still a need for a tablet dispensing device which allows to preserve the stored tablets from the external environment, in particular from moisture and oxygen. In particular, there is still a need for a tablet dispensing device with an improved airtight seal and barrier properties for limiting the ingress of moisture and oxygen within the device.

### SUMMARY OF THE INVENTION

It is a first object of the invention to provide a tablet dispensing device, comprising:
a tubular container body including two extremities, a tubular side wall in between, the tubular side wall defining an internal dispensing space capable of receiving a tablet to be dispensed, and a tablet dispensing opening formed on the tubular side wall; a sleeve configured to slide longitudinally over the tubular side wall and between the two extremities, between a first position, in which the sleeve covers in an airtight manner the tablet dispensing opening, and a second position, in which the sleeve uncovers the tablet dispensing opening.

Advantageously, the tablet dispensing device comprises at least two peripheral sealing ribs arranged on an outer surface of the tubular side wall and/or on an inner surface of the sleeve, the tablet dispensing opening being between the two peripheral sealing ribs when the sleeve is at the first position.

In some examples, at least one sealing rib is arranged on the outer surface of the tubular side wall and at least one sealing rib is arranged on the inner surface of the sleeve.

In some examples, the two extremities of the tubular container body are provided with an abutment that prevents the sleeve from moving beyond the tubular sidewall of the tubular container body.

In some examples, the sleeve comprises a tubular side wall and two extremities, and the two extremities are open.

In some examples, the tablet dispensing device comprises a tamper-evident element.

In some examples, the tamper-evident element prevents longitudinal sliding of the sleeve over the tubular side wall, or the tamper-evident mechanism is a removable tab blocking the tablet dispensing opening.

In some examples, the tamper-evident element, the sleeve and, optionally, a cap for closing one of the two extremities of the tubular container body, are integrally formed in a single molded piece.

In some examples, the tamper-evident element, and a cap for closing one of the two extremities of the tubular container body are integrally formed in a single molded piece.

In some examples, the cap is press-fit into the tubular container body.

In some examples, the tablet dispensing device further comprises at least one active agent in fluid communication with the internal dispensing space.

In some examples, the active agent is arranged in a cap closing a respective one of the two extremities of the tubular container body.

In some examples, the tablet dispensing opening is flush with a support surface delimiting the internal dispensing space, the support surface being optionally inclined relative to a plane transverse to the tubular container body, the inclination of the support surface relative to the plane transverse to the tubular container body being optionally higher than 1° and/or lower than 30°, preferably from 1° to 10°, and more preferably from 3° to 6°.

In some examples, the tubular container body further includes a hollow space, the support surface delimiting the internal dispensing space on one side and the hollow space on another side.

In some examples, the support surface comprises one or more surface ribs oriented towards the tablet dispensing opening.

In some examples, the tubular container body and the sleeve are made of different materials.

In some examples, the tubular container body comprises a tablet storage space in communication with the internal dispensing space.

In some examples, the tubular container body is connected to a container having a tablet storage space, the tablet storage space being in communication with the internal dispensing space.

The invention further relates to a kit comprising:
one or more tubes each including two closed ends, defining a tablet storage space containing tablets and configured to be opened at one respective end; and
the tablet dispensing device as described above and configured to be assembled to the respective open end of each tube.

The invention further relates to the use of the tablet dispensing device as described above, or of the tablet dispensing kit as described above, for the distribution of pharmaceutical, nutraceutical, veterinary and/or agro-alimentary products.

### DESCRIPTION OF EMBODIMENTS

The invention will now be described in more detail without limitation in the following description.

The present invention relates to a tablet dispensing device comprising a tubular container body and a sleeve.

By the term “tubular” is meant a shape of a cylinder with a circular or non-circular base. For example, the base may be a disc, an oval, a square, a rectangle, a regular or non-regular polygon, or a combination of planar surfaces and/or curved surfaces. Preferably, the base is a disc or an oval.

The tubular container body comprises two extremities, an upper extremity and a lower extremity in use, and a tubular side wall extending between the two extremities. The tubular side wall defines an internal dispensing space capable of receiving a tablet to be dispensed.

The terms “upper”, “lower”, “longitudinal”, “above” and “below” refer to the vertical direction when the container is oriented for use, with the dispensing opening being down (the tablets being subjected to gravity for dispensing).

The term “tablet” is intended to cover any form of pills, tablets, wafers and the like. Preferably, the tablet has the form of a flat wafer. The tablets according to the invention may be pharmaceutical, nutraceutical, veterinary and/or agro-alimentary tablets.

The tablets may have a width Wₜ from 5 to 45 mm, preferably from 10 to 30, and more preferably from 15 to 30 mm. By “width” is meant a dimension of the tablets orthogonal to the direction of the tubular side wall. It can be the diameter of the cylinder in case of a cylindrical tablet, or it can be the maximum dimension or the minimum dimension orthogonal to the direction of the tubular side wall for a parallelepipedal tablet. For example, the tablets may have a width Wₜ from 5 to 10 mm; or from 10 to 15 mm; or from 15 to 20 mm; or from 20 to 25 mm; or from 25 to 30 mm; or from 30 to 35 mm; or from 35 to 40 mm; or from 40 to 45 mm.

Furthermore, the tablets may have a thickness T from 1 to 15 mm, and preferably from 2 to 10 mm. Therefore, the tablets may have a thickness from 1 to 5 mm; or from 5 to 10 mm; or from 10 to 15 mm.

The tubular container body further comprises a tablet dispensing opening formed on the tubular side wall. The tablet dispensing opening communicates with the internal dispensing space and may be located proximal to lower extremity of the tubular container body. The dimension of the tablet dispensing opening may correspond to the width and height of one tablet. Therefore, the position and dimension of the tablet dispensing opening may ensure that only one tablet at a time falls out of the tablet dispensing device through said tablet dispensing opening.

For example, the width Wₒ of the tablet dispensing opening may be from 5 to 50 mm, and preferably from 6 to 40 mm. For example, the width of the tablet dispensing opening Wₒ may satisfy the relation:

1 mm<W₀−Wₜ<⅓×Wₜ

where Wₜ is the width of a tablet. By “width” is meant the extent of the tablet dispensing opening orthogonal to the tubular side wall. In other words, “width” means the distance between the lateral extremities of the dispensing opening.

The height H of the tablet dispensing opening may notably be from 2 to 30 mm, and preferably from 2 to 20 mm. For example, the height H of the tablet dispensing opening may satisfy the relation:

T<H<1,5×T

where T is the thickness of a tablet.

The two extremities of the tubular container body may be closed. For example, the two extremities may be closed by a cap, by a wall integrally formed with the tubular sidewall and/or by a storage cartridge (or a tube) containing a stack of tablets. The storage cartridge can for example be a container comprising a tablet storage space able to supply the internal dispensing space with tablets.

Alternatively, at least one of the two extremities of the tubular container body may be open. It can for example allow the filling of the tubular side wall with tablets, before the opened extremity is hermetically sealed (in order to preserve the tablets from the external atmosphere).

The sleeve according to the invention is configured to slide longitudinally over the tubular side wall and between the two extremities. In other words, the sleeve is arranged outside of the tubular container body and is configured to slide along the external surface of the tubular container body, without however extending beyond the extremities of the tubular container body (whatever the position of the sleeve). The sleeve may comprise a tubular side wall and two extremities, the two extremities being open. The tubular side wall of the sleeve is open at its two extremities. In other words, the sleeve is not closed at its ends (or at the extremity of its tubular side wall) and does not include any top or bottom wall such as to allow translation of the sleeve over the tubular container body. Whatever the position of the sleeve, each extremity of the sleeve is configured to stay between the extremities of the tubular container body without extending beyond them. Therefore, the two extremities of the tubular container body may remain at least partly uncovered by the sleeve, whatever the relative position of the sleeve with the tubular container body.

The sleeve is configured to slide, relatively to the tubular container body, from a first position in which the sleeve covers in an airtight manner the tablet dispensing opening, to a second position in which the sleeve uncovers the tablet dispensing opening. In the first position, the sleeve airtightly seals the dispensing opening. In the second position, the sleeve may be arranged on one longitudinal side of the tablet dispensing opening. In other words, the sleeve is preferably beyond the dispensing opening when in the second position, more preferably above the dispensing opening.

Therefore, the present invention makes it possible to provide a tablet dispensing device which can facilitate the user's manipulations as it can be easily handled, notably by a user with only one hand. More particularly, the user may hold the tablet dispensing device by the sleeve with one hand. By pushing (preferably with the thumb) on the upper extremity of the container body (which is not covered by the sleeve), the tubular container body can be slid relatively to the sleeve towards a first direction in order to uncover the tablet dispensing opening. As the sleeve slides between the two extremities of the tubular container body and not beyond them, the user may for example place his thumb on the one of the two extremities of the tubular container body and facilitate the movement of the sleeve. After the distribution of a tablet and in order to cover the tablet dispensing opening, the tubular container body can be slid relatively to the sleeve towards a second direction opposite to the first direction. Again, as the sleeve does not slide beyond the extremities of the tubular container body, the user may place the second of the two extremities of the tubular container body on a surface (a table for example) to facilitate the movement. Furthermore, the invention makes it possible to distribute tablets one-by-one while at the same time avoiding contact of the tablet with the user as well as external contamination of the tablets.

The tablet dispensing device may further be provided with a tablet storage space in communication with the internal dispensing space. The tablet storage space may be part of the tablet dispensing device or may be a separate part connected to the tablet dispensing device.

The tablet storage space is intended to contain a stack of tablets. “In communication” means that a tablet can pass from the tablet storage space to the internal dispensing space. The tablet storage space is thus intended to supply the internal dispensing space with tablets.

In a first configuration of the tablet dispensing device, the tubular container body may comprise a tablet storage space in communication with the internal dispensing space. The tablet storage space may be directly adjacent to the internal dispensing space. In other words, the tablet storage space may be defined by the tubular side wall also defining the internal dispensing space. In this case, the tablet storage space is part of the tubular container body, and the tablets are stacked inside the tablet storage space and the internal dispensing space and can be dispensed through the tablet dispensing opening. The separation between the internal dispensing space and the tablet storage space may therefore be undistinguishable. The tablet dispensing device according to the first configuration presents an advantage as it facilitates the fabrication and the assembling process. In examples, the tablet storage space may be integrally formed with the internal dispensing space. In such examples, as the tablet storage space and the internal dispensing space are integrally formed (both contained within the tubular side wall of the tubular container body), it is not necessary to fabricate two parts, which limits the number of parts to be fabricated and assembled.

Alternatively, in a second configuration, the tubular container body may be connected to a container having a tablet storage space configured to be in communication with the internal dispensing space. More particularly, the tablet storage space may be in a part that is separate from the tubular container body and that is configured to be connected and disconnected to the tubular container body. In other words, the tablet storage space may be defined by a tubular side wall of the container, which can be connected to the tubular container body in order that a tablet can pass from the tablet storage space to the internal dispensing space. In this case, the separation between the internal dispensing space and the tablet storage space may be distinguishable. For example, the tubular container body may be detachably connected to the container comprising a stack of tablets. This container may be a tube defining a tablet storage space and comprising a stack of tablets, the tube being initially closed in an airtight manner at its two extremities (before being connected to the tubular container body, for a better preservation of the tablets). For example, initially, a first extremity of the tube may be sealed with an aluminum film or a sealing cap while a second extremity of the tube may be closed with a wall (forming for example the bottom of the tube), preferably integrally formed with the tubular side wall of the container or tube. After opening the first extremity by tearing the aluminum film or removing the sealing cap, the tube may be connected to the tubular container body of the dispensing device. After connection, the tablet storage space is in communication with the internal dispensing space and the tablets, being in the tablet storage space and the internal dispensing space, can be distributed through the tablet dispensing opening. In fact, when there are no more tablets in the tablet storage space and the internal dispensing space, the tube may be disconnected and replaced with another tube filled with a stack of tablets, while the tubular container body remains the same and can therefore be used over a long period of time.

The tablet dispensing device may comprise at least two peripheral sealing ribs arranged on an outer surface of the tubular side wall of the tubular container body and/or an inner surface of the sleeve. By “peripheral” is meant that each sealing rib extends over the entire circumference of the outer surface of the tubular side wall of the tubular container body or the inner surface of the sleeve in a continuous way. Preferably, the peripheral sealing ribs have a rounded surface, in other words they present no sharp edges on their surface.

When the sleeve is at the first position, the tablet dispensing opening is arranged between the two peripheral sealing ribs. This makes it possible to achieve sealing the tablet dispensing opening in an airtight manner in order to preserve the tablets from external environment (moisture and oxygen). A portion of the tubular side wall comprising the tablet dispensing opening is indeed sealed between the sealing ribs thanks to the contacts of the sealing ribs with the facing surfaces.

The sealing ribs may be arranged on the outer surface of the tubular side wall. In this case, the tablet dispensing opening is sealed thanks to the contacts of the sealing ribs with the inner surface of the sleeve.

Alternatively, the sealing ribs may be arranged on the inner surface of the sleeve. In this case, the tablet dispensing opening is sealed thanks to the contacts of the sealing ribs with the outer surface of the tubular side wall.

Alternatively, at least one sealing rib may be arranged on the outer surface of the tubular side wall, and at least one sealing rib may be arranged on the inner surface of the sleeve. In this case, the tablet dispensing opening is sealed thanks to the contact of the sealing rib arranged on the outer surface of the tubular side wall with the inner surface of the sleeve, and thanks to the contact of the sealing rib arranged on the inner surface of the sleeve with the outer surface of the tubular side wall. Preferably, one sealing rib may be arranged on the outer surface of the tubular side wall and one sealing rib may be arranged on the inner surface of the sleeve. This presents the advantage of facilitating the fabrication process of both the sleeve and the tubular container body. In fact, when the sleeve and the tubular container body are fabricated by a molding process, the release of each molded part (sleeve and tubular container body) from the mold is greatly facilitated (the sealing ribs are forming undercuts which preferably require to be forcibly released from the injection mold). When the sleeve is at the second position, both sealing ribs are found on the one side of the tablet dispensing opening (preferably above the tablet dispensing opening) so that the sleeve does no longer cover the tablet dispensing opening. The presence of the sealing ribs also makes it possible to keep the sleeve at the second position (where the tablet dispensing opening is uncovered) which means that the sleeve may remain at the second position, despite the action of gravity (for example by friction).

Preferably, the difference of diameter between the sealing rib and the facing surface is 0.1 to 0.6 mm, more preferably from 0.2 to 0.4 mm. Such values allow to combine an optimum airtightness with a rather comfortable use of the dispensing device (without required too high force for the user in order to move the sleeve relatively to the tubular container body). When the sealing rib is on the outer surface of the tubular container body, such values represent the difference between the outer diameter of the sealing ribs and the inner diameter of the sleeve (the outer diameter of the sealing rib being made greater than the inner diameter of the sleeve for airtightness). When the sealing rib is on the inner surface of the sleeve, such values represent the difference between the outer diameter of the tubular container body and the diameter of the sealing rib (the outer diameter of the tubular container body being made greater than the diameter of the sealing rib for airtightness).

The tubular dispensing device can comprise stop elements able to prevent the sleeve from moving beyond the extremities of the tubular container body.

For example, at least one of the two extremities of the tubular container body may be provided with an abutment which prevents the sleeve from moving beyond an extremity of the tubular container body. The abutment may be provided directly on the tubular container body or on a separate part that is fixed to the tubular container body (for example a cap closing an extremity of the tubular container body). The abutment may protrude beyond the outer surface of the tubular container body in a direction perpendicular to the outer surface of the tubular container body. Preferably, both extremities are provided with an abutment. The abutment may extend over the entire periphery of the upper and/or the lower extremity of the tubular container body. Alternatively, the abutment may extend over the periphery of the upper and/or the lower extremity of the tubular container body in a discontinuous manner. In a further alternative, the abutment can be a local abutment (i.e. the abutment does not need to extend over the periphery of the upper and/or the lower extremity of the tubular container body). Moreover, the local abutment is preferably in alignment with the dispensing opening. Such a localized abutment has the advantage of providing to the user a visual indication of the position of the dispensing opening (that can be hidden by the sleeve when the tablet dispensing device is in the first -closed- position), allowing the user to easily orient the device for dispensing a tablet.

Alternatively, the sealing ribs can serve as stop elements. For example, when the sealing ribs are arranged on two different parts (one on the outer surface of the tubular side wall, and one on the inner surface of the sleeve), they can interact when the sleeve is at the second position, such that the rib on the sleeve comes in contact with the rib on the tubular side wall without the possibility to pass through it (i.e. the rib on the tubular side wall provides an abutment preventing the rib on the sleeve from moving beyond).

The tubular container body and the sleeve may be manufactured from the same materials. Alternatively and preferably, the tubular container body and the sleeve may be manufactured from different materials. Such materials are preferably thermoplastic materials having a low permeability to moisture and/or oxygen, preferably to moisture. Thermoplastic materials with low permeability to moisture include for example polyolefins (such as polyethylene, polypropylene), polyesters and cycloolefins. Polyolefins, in particular polypropylene and/or polyethylene, are preferred. Thermoplastic materials with low permeability to oxygen include for example polyamides, polyvinylidene chloride (PVDC), ethylene vinyl alcohol (EVOH) and cellulosic polymers.

The sleeve, the container body or both of them can be manufactured, preferably molded, from a single resin, or they can be manufactured from a composite structure (multi-layer molding, sleeving, etc.) to combine material properties and achieve low permeability to both moisture and oxygen.

For example, the tubular container body may be manufactured from polyethylene and the sleeve may be manufactured from polypropylene, or the tubular container body may be manufactured from polypropylene and the sleeve may be manufactured from polyethylene. The fact that the sleeve and the tubular container body are manufactured from different materials makes it possible to facilitate the sliding of the sleeve over the tubular container body.

The tubular container body and/or the sleeve may be manufactured from a material including an active filler such as a desiccant or an oxygen scavenger. Using active fillers embedded in the material of the sleeve and/or the tubular container body, may further increase barrier properties to moisture or to oxygen. In particular, an active filler may reduce the permeability of the material to moisture and/or oxygen, the material acting as an active barrier able to adsorb or scavenge the gaseous substances permeating from the surrounding atmosphere towards the inner space of the tablet dispensing device, before the gas molecules can reach this inner space. Examples of material including an active filler are given later.

The tubular container body may also be provided with an area on its tubular side wall made of a transparent material, for example a transparent plastic. This allows the user to see the remaining tablets in the tablet dispensing device, for example so that he/she can be informed of the number of remaining tablets.

When the tablet dispensing device is according to the first configuration, the tubular container body may have a length from 7 to 20 cm, and preferably from 9 to 15 cm. By “length” is meant the dimension of the tubular container body parallel to the tubular side wall. Preferably, the length of tubular container body allows to contain at least 10 tablets, more preferably at least 15 tablets.

When the tablet dispensing device is according to the second configuration, the tubular container body may have a length from 4 to 10 cm, and preferably from 5 to 8 cm. Preferably, the length of the tubular container body allows to contain at least 2 tablets, preferably at least 3 tablets.

When the tablet dispensing device is according to the first configuration, the sleeve may have a length from 5 to 15 cm, and preferably from 5 3to 12 cm. By “length” is meant the dimension of the sleeve parallel to the tubular side wall.

When the tablet dispensing device is according to the first configuration, the sleeve may have a length from 1 to 8 cm, and preferably from 1 to 3 cm.

The sleeve may comprise one or more holes or cuts on its tubular side wall. These holes or cuts however are present at an area outside the area required for the airtight sealing of the tablet dispensing opening can still be achieved (between the sealing ribs when the sleeve is in the closed position).

Alternatively, the tubular side wall of the sleeve is devoid of holes.

The tablet dispensing device may further be provided with at least one cap configured to close at least one extremity of the tubular container body. The cap may close the upper and/or the lower extremity of the tubular container body. The cap(s) makes it possible to close the internal space of the tablet dispensing device (tablet dispensing space and/or tablet storage space) in order to preserve the tablets from the external atmosphere (in particular from moisture and oxygen). Preferably, an airtight seal is established between the cap(s) and the tubular container body. More preferably, the cap seals an extremity of the tubular container body in an airtight manner. The tablet dispensing device may comprise one cap closing only one of the two extremities of the tubular container body. Alternatively, the tablet dispensing device may comprise two caps for closing each of the two extremities of the tubular container body. The cap(s) may for example be press-fit into the tubular container body, preferably in an airtight manner.

The tablet dispensing device may also comprise at least one active agent in fluid communication with the internal dispensing space. The active agent is capable of interacting with at least one gaseous substance such as moisture, oxygen, volatile organic compounds and/or odors. In particular, the active agent may be an agent capable of trapping (and/or releasing when desired) at least one gaseous substance such as moisture, oxygen, volatile organic compounds and/or odors. Preferably, the active agent is capable of trapping moisture and/or oxygen.

The presence of the active agent makes it possible to maintain the quality of the sensitive products during their storage, for example maintaining the physical and/or chemical integrity as much as possible and/or as long as possible, in particular by protecting the products against gaseous substances likely to impair their integrity and/or their properties.

The active agent may be a desiccant and/or an oxygen scavenger. Preferably, the active agent is a desiccant.

The desiccant may be selected from silica gel, calcium oxide, barium oxide, clay, molecular sieve, zeolites, deliquescent salt (such as for example calcium chloride, aluminum chloride, lithium chloride, calcium bromide, zinc chloride, magnesium sulfate, potassium acetate) or any combination thereof.

The oxygen scavenger may be selected from metallic powders or metallic oxides having a reducing capacity (such as for example zinc-, tin- or iron-based oxygen scavengers), ascorbic acid, polymer-based oxygen scavengers, or any combination thereof.

The active agent may be arranged in a compartment in the tablet dispensing device.

For example, the active agent may have the form of a capsule being arranged on one of the two extremities of the tubular container body, or the active agent may have the form of powder or granules arranged in a chamber on one of the two extremities of the tubular container body. Said chamber may be part of a cap which is configured to close the upper and/or the lower extremity of the tubular container body. In case the tablet dispensing device is according to the second configuration, the active agent may be located in the container or tube defining the tablet storage space, and preferably in a capsule or housing arranged in the tube and adjacent to the closed extremity of the tube.

Alternatively, the active agent can be mixed with a polymer material. The resulting active material including the active agent (or active filler) can be used to form (for example by injection molding or extrusion molding) an active article (for example an active insert or an active canister) arranged within the tubular container body. The polymer used for the formation of the active article may be for example, a thermosetting or a thermoplastic, preferably a thermoplastic polymer.

The polymer is preferably substantially permeable to the gaseous substance interacting with the active agent. Furthermore, the polymer may be selected from polyolefin-based polymers, for example polyethylene, HDPE, LDPE, polypropylene (PP), polystyrene (PS), polyvinyl chloride (PVC), ethylene vinyl acetate (EVA), ethylene-vinyl acetate copolymer (EVOH), a cyclic olefin copolymer (COC); polymers based on polyesters, for example polycaprolactone (PCD), polylactic acid (PLA), polyethylene terephthalate (PET), polybutylene terephthalate (PBT), polycarbonate (PC), polyoxymethylene (POM), polyamide, PPS sulphuretted polyethylene, BOPP, polyether block amide (PEBA) or cellulose or any combination thereof.

As an example, the tubular container body may comprise an article made of an active material comprising a blend of polypropylene and molecular sieve at a filling rate of 10 to 70% by weight. The blend can further include polyether block amide in order to increase moisture absorption kinetic of the active article.

The tubular container body may also comprise a support surface flush with the tablet dispensing opening, preferably flush with the lower limit (or lower edge) of the tablet dispensing opening. This support surface delimits the internal dispensing space. In this manner, a tablet lying on this support surface faces the dispensing opening. This support surface can be provided by a wall integrally formed with the tubular side wall of the tubular container body. The support surface may be horizontal or present an inclination relative to a plane transverse to the tubular container body. The inclination is preferably directed towards the dispensing opening. This inclination may be for example from 1° to 30°, preferably from 1° to 10°, and more preferably from 3° to 6°. Thus, this inclination may be from 1 to 5°; or from 5 to 10°; or from 10 to 15°; or from 15 to 20°; or from 20 to 25°; or from 25 to 30°. This inclination makes it possible to facilitate the distribution of the tablet through the tablet dispensing opening. The support surface may further present one or more surface ribs. The surface ribs may be linear. The surface ribs may be directed towards the dispensing opening. The presence of the surface ribs makes it possible to facilitate the distribution of the tablet by guiding the tablet towards the tablet dispensing opening while at the same time minimizing the contact and the friction between the tablet and the support surface. The surface ribs may present an inclination relative to a plane transverse to the tubular container body. For example, the support surface can be horizontal whereas the surface ribs are inclined. Examples of inclination angles are given above and are also applicable for the surface ribs. The support surface can also be provided with holes. This can be advantageous if the support surface is adjacent to a housing comprising an active agent as the holes allow a fluid communication between the internal dispensing space and the housing and allow the gaseous substances (such as moisture or oxygen) to be trapped by the active agent of the housing.

The tubular container body may further include a hollow space, the support surface delimiting the internal dispensing space on one side and the hollow space on the other side. The presence of the hollow space presents an advantage as it facilitates the manufacturing process of the tubular container body and allows the molding in a more accurate manner. Indeed, by avoiding a massive piece (without hollow space) and then shrinkage, a well-defined outer surface on the tubular side wall can be molded. It can be particularly advantageous when this well-defined surface is intended to contact a facing sealing rib such as to establish an airtight seal. The hollow space can further be used as a housing for containing an active agent (for example a desiccant).

The tablet dispensing device may further comprise a tamper-evident element. The tamper-evident element provides evidence of first opening or first use of the tablet dispensing device. The tamper-evident element can be configured to close (or to obstruct) the tablet dispensing opening. Alternatively, the tamper-evident element can be configured to prevent the tablet dispensing opening from being uncovered. When first used, the user must first break the tamper-evident element to free the tablet dispensing opening and access the tablets stored inside the tablet dispensing device. Accordingly, the tamper-evident mechanism gives a clear indication to the user once the closure has been opened for the first time.

The tamper-evident element may be arranged close to the lower extremity of the tubular container body. Alternatively, the tamper-evident element may be arranged close to the upper extremity of the tubular container body.

The tamper-evident mechanism may prevent longitudinal sliding of the sleeve over the tubular side wall of the tubular container body. In other words, the tamper-evident element may prevent the moving of the sleeve from the first (closed) position to the second (opened) position.

The tamper-evident element may be a tearable band or ring connected to the sleeve. It can for example be connected to the sleeve by means of frangible bridges or by means of a tearable line of weakness (or decrease in thickness of the plastic material). In this case, the sleeve and the tamper-evident element may be integrally formed in a single-molded piece. When first opened, the temper-evident element is removed in order to release the sleeve so that the sleeve can slide in the second (opened position).

The tamper-evident element may be a tearable band that connect the sleeve to a cap configured to close the lower extremity of the tubular container body. This makes it possible to prevent the longitudinal sliding of the sleeve over the tubular side wall. In this case, the sleeve, the cap and the tamper-evident element may be integrally formed in a single-molded piece.

Alternatively, the tamper-evident element may be a tearable band extending over the entire circumference of the tubular side wall and over one portion of the length of the tubular side wall. In this case, the tamper-evident element may be connected to a cap configured to close the upper extremity of the tubular container body, for example by a plurality of frangible elements. This makes it possible to prevent the longitudinal sliding of the sleeve over the tubular side wall. In this case, the cap and the tamper-evident element may be integrally formed in a single-molded piece.

The tamper-evident element may also be provided with a seizure member to grip the tamper-evident element and facilitate removal of the tamper-evident element.

Alternatively, the tamper-evident element may be a tearable band comprising a continuous or discontinuous line of weakness in the wall; in other words, the material of the wall may present reduced thickness in a certain area instead of a plurality of frangible elements.

Alternatively, the tamper-evident element may be a removable tab directly blocking the tablet dispensing opening. The tamper-evident element can be connected to the part of the tubular side wall surrounding the dispensing opening, for example with frangible elements.

The tablet dispensing device may also comprise a compensation element (or shock absorber). The compensation element may be in the tubular container body and/or in the container configured to be connected to the tablet dispensing device. A compensation element can be advantageous when the packaged products (tablets) have a porous and friable structure (in particular when they are effervescent tablets), which makes them particularly fragile under impact and abrasion. The compensation element allows to limit the movement of the tablets in the inner space (internal dispensing space, tablet storage space), and then prevent mechanical damage that is generally caused during the handling and transportation of the stored products. Non-limiting examples of compensation element can be given in U.S. Pat. No. 8,763,797 or in EP 2125553.

The present invention further relates to a kit comprising one tablet dispensing device according to the second configuration and a plurality of containers comprising tablets and configured to be connected to the tablet dispensing device.

The present invention further relates to a kit comprising a plurality of tablet dispensing devices according to the second configuration, each tablet dispensing device being connected to a container comprising tablets.

The present invention also relates to a method for manufacturing the tablet dispensing device. This method may be thermoplastic injection molding. The method may comprise the manufacture of the tubular container body by thermoplastic injection molding, for example as a single-molded piece. The method may also comprise the manufacture of the sleeve by thermoplastic injection molding which may be, for example, a single molded piece on its own or formed as a single molded piece with the tamper evident element and a cap. The method may alternatively comprise manufacturing the tamper-evident element and the cap as a single molded piece.

The present invention may further comprise a method for assembling said parts together along with other additional parts, in an easy manner, in order to obtain the tablet dispensing device. For example, the sleeve may be assembled over the tubular container body. The tubular container body may be closed by cap(s) on the upper and/or lower extremity of the tubular container body. An airtight seal between the cap(s) and the tubular container body can be established, for example by gripping or press-fitting the cap(s) into the tubular container body. Furthermore, a press-fit allows to hold the cap on the tubular container body without requiring welding. The method may further comprise filling the tubular container body with a stack of tablets prior to press-fitting the cap(s) with the tubular container body. For example, when the tablet dispensing device is according to the first configuration, the tubular-container body may be filled with tablets. Alternatively, when the tablet dispensing device is according to the second configuration, the container may be filled with tablets. In this case, the method may further comprise placing an aluminum film on the open extremity of the container or directly connecting the open extremity of the container with the tablet dispensing device.

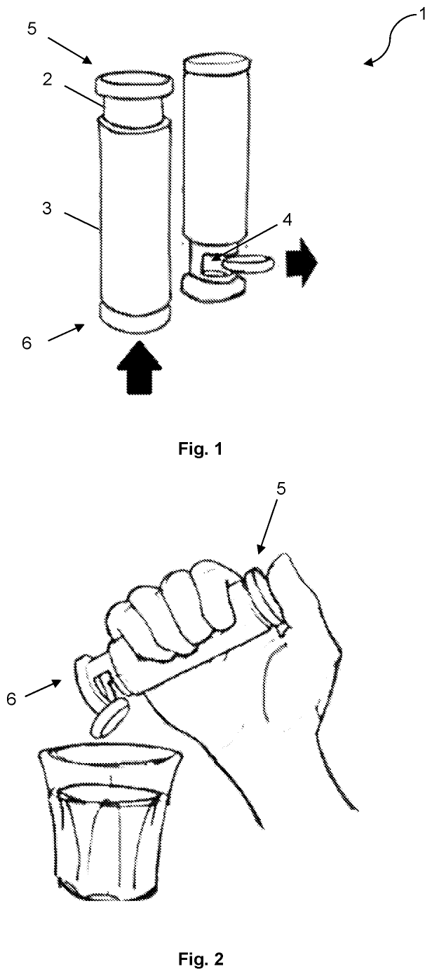

Examples of different tablet dispensing devices according to the invention will now be described and detailed referring to FIGS. 1 to 21. In the following figures the words “upper” and “lower” are used in reference to the direction of the tablet dispensing device when in use. More particularly, during the use of the tablet dispensing device, the tablet dispensing device may be handled vertically gravity to operate dispensing of a tablet through the tablet dispensing opening.

FIG. 1 illustrates a tablet dispensing device 1 according to the first configuration, comprising a tubular container body 2, a sleeve 3 and a dispensing opening 4. The tubular container body 2 comprises a tablet storage space. This means that the tubular side wall defining the tablet storage space is integrally formed with the tubular side wall of the internal dispensing space. Longitudinal movement of the sleeve 3 between a lower extremity 6 and an upper extremity 5 of the tubular container body 2 and towards a first direction (from a first position in which the sleeve covers the tablet dispensing opening, to a second position in which the sleeve uncovers the tablet dispensing opening) makes it possible to uncover the tablet dispensing opening 4.

FIG. 2 illustrates a user holding the tablet dispensing device 1 with one hand. As the sleeve 3 slides between the lower extremity 6 and the upper extremity 5 and not beyond these extremities, the user may place his thumb on the one of the two extremities (the upper extremity 5 for example) and facilitate the movement of the sleeve 3. Then, by tilting horizontally the tablet dispensing device 1 over a glass for example, the tablet is distributed. Then, the sleeve 3 can slide relatively to the tubular container body towards a second direction opposite to the first direction to cover the tablet dispensing opening 4 (towards the first position of the sleeve). Or equivalently, the tubular container body can slide relatively to the sleeve 3 towards the first direction. Again, as the sleeve 3 does not slide beyond the upper extremity 5 and the lower extremity 6 of the tubular container body 2, the user may place the second of the two extremities (the lower extremity 6 for example) on a surface (a table for example) to facilitate the movement of the sleeve 3 (not illustrated in the figures).

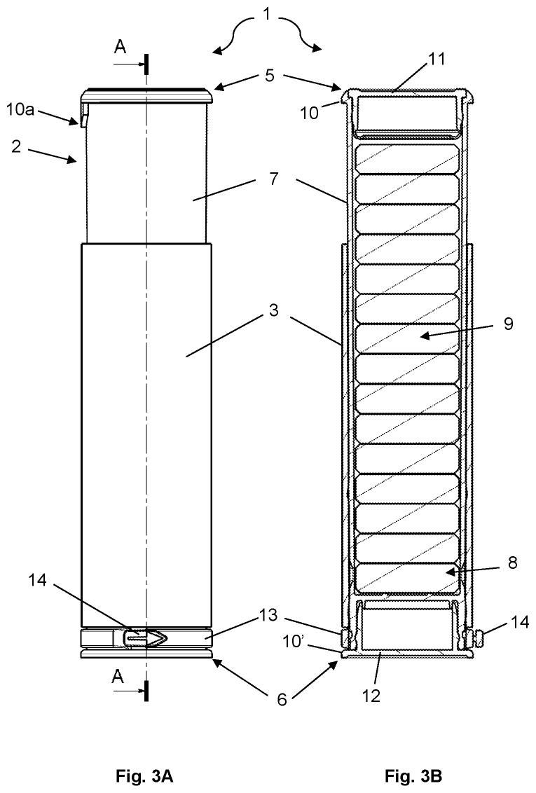

FIGS. 3 to 9 illustrate in more detail tablet dispensing device 1.

FIGS. 3A and 3B illustrate respectively a profile view and a cross sectional view (along line A-A) of the tablet dispensing device 1 comprising a tubular container body 2 and a sleeve 3 arranged on the outer surface of the tubular container body 2.

The tubular container body 2 comprises an upper extremity 5, a lower extremity 6 and a tubular side wall 7 defining an internal dispensing space 8 capable of receiving a stack of tablets. In this example, the tablet dispensing device 1 is according to the first configuration, in other words the tablet storage space 9 is part of the tubular container body 2.

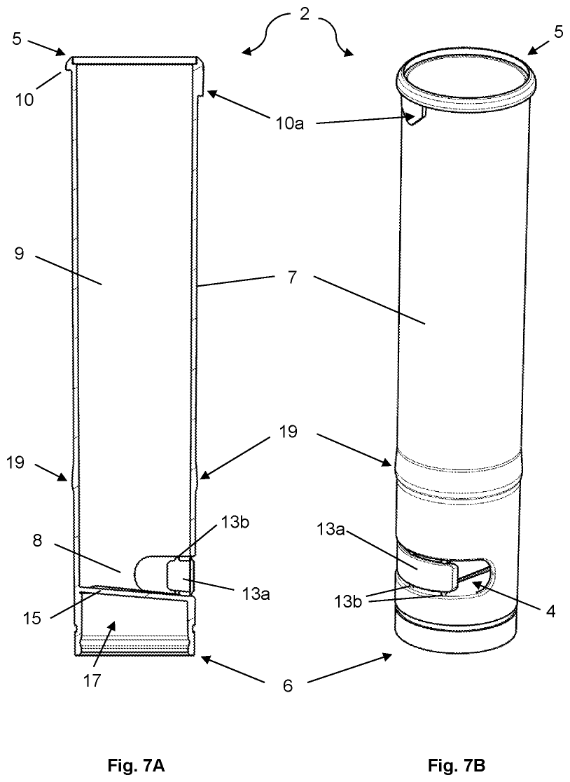

The tubular container body 2 may be provided with an abutment 10 formed at the upper extremity 5 of the tubular container body 2. The abutment can extend over the entire periphery of the upper extremity 5 of the tubular container body 2. Alternatively, the abutment can be a local abutment 10a (shown in FIGS. 3A, 7A and 7B) at the upper extremity. This local abutment is in longitudinal alignment with the dispensing opening. In this manner, the abutment further serves as a visual indication of the position of the dispensing opening (for an easier orientation and use of the dispensing device).

The tablet dispensing device 1 may further comprise a tamper-evident element 13 configured to prevent the tablet dispensing opening 4 from being uncovered. The tamper-evident element 13 may be arranged close to the lower extremity 6 of the tubular container body 2.

The upper extremity 5 may be sealed with an upper cap 11. In this example, the top surface of the upper cap 11 is preferably flush with the upper extremity of the tubular container body. Furthermore, the overall external diameter of the upper cap 11 is preferably smaller than the overall diameter of the upper extremity of the tubular container body. In other words, the upper cap does not extend radially or longitudinally from the tubular container body, which makes it very difficult to nearly impossible for a user to grip and to remove the upper cap 11 from the tubular container body once it has been press-fit onto it. Optionally, the upper cap 11 may be provided with a compensation element in order to limit the movement of the tablets in the internal space.

The lower extremity 6 may be sealed with a lower cap 12. In this example, the lower cap 12 provides an abutment 10′, which extends over the entire periphery of the lower cap 12. The upper cap 11 and/or the lower cap 12 may be press-fit into the tubular container body 2. By “press-fit” it is meant a fit between two parts in which one part is inserted by force (gripped or tightened) in the other part. Furthermore, the press-fit between the cap and the tubular container body is preferably peripheral (La it extends over the entire periphery of the tubular container body). This has the advantage to establish an airtight seal between the cap and the tubular container body (for preservation of the tablets inside the tubular container body).

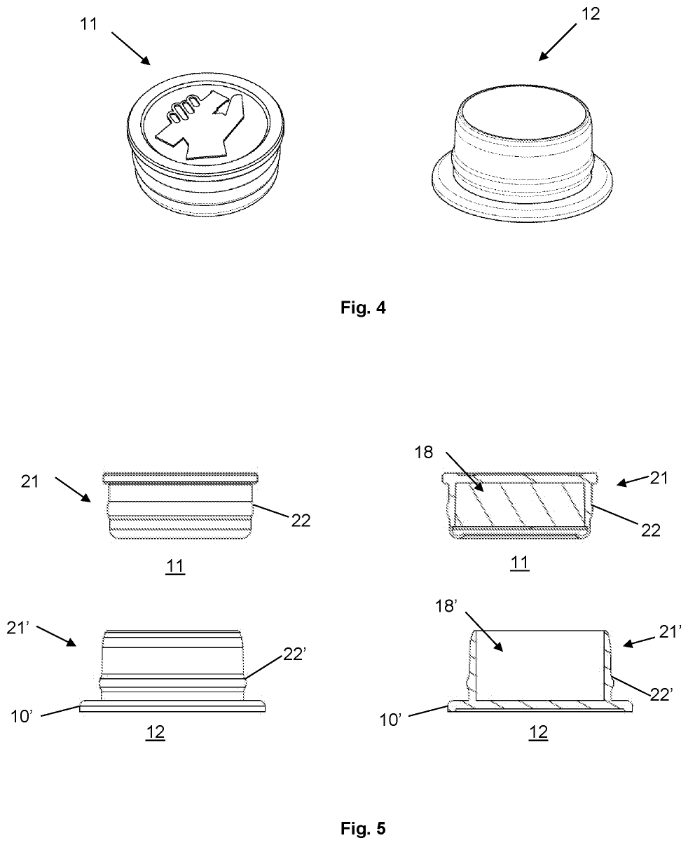

The upper cap 11 and the lower cap 12 are illustrated in more detail in FIGS. 4 and 5. FIG. 4 shows perspective views of the upper cap 11 and the lower cap 12. FIG. 5 shows a profile view and a cross sectional view of the upper cap 11 and the lower cap 12. The upper cap 11 and/or the lower cap 12 may comprise a lateral wall 21, 21′ which defines a chamber 18, 18′. One protrusion 22, 22′ may be disposed on the periphery of the lateral wall 21, 21′ in a continuous or a discontinuous way, so that the upper cap 11 and/or the lower cap 12 may be press-fit in the tubular container body 2. The peripheral protrusion 21 of the cap 11 is preferably continuous such as to establish an airtight seal with the tubular container body 2.

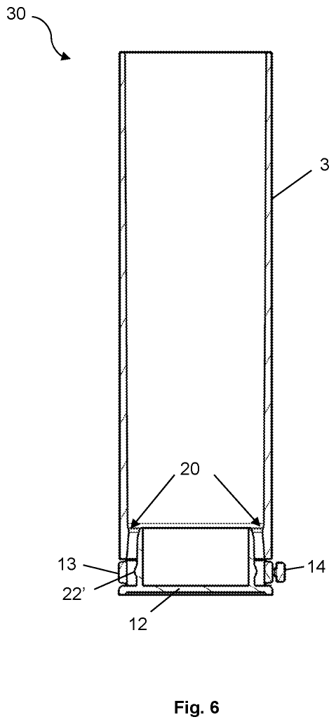

FIG. 6 shows a cross sectional view of the sleeve 3, the tamper-evident element 13 and the lower cap 12. With reference to FIGS. 3 and 6, the tamper-evident element 13 may be a tearable band connected to the sleeve 3 and to the lower cap 12 in order to prevent the longitudinal sliding of the sleeve 3 over the tubular side wall 7. The tearable band can be connected to the sleeve 3 to the lower cap 12 by a plurality of frangible elements (or breakable bridges) or by lines of weakness in the plastic material. The tamper-evident element 13 may also be provided with a seizure member 14 to grip the tamper-evident element 13 and facilitate removal of the tamper-evident element 13. Therefore, before removing the tamper-evident element 13, the sleeve 3 is connected to the lower cap 12 via the tamper-evident element 13. In order to open the tablet dispensing device 1 for the first time, the tearable band is removed (by breaking the frangible elements or by tearing the weakened lines in the material of the band), and the sleeve 3 is released from the lower cap 12.

In this case, the sleeve 3, the lower cap 12 and the tamper-evident element 13 (with its seizure member 14) may be integrally formed in a single-molded piece 30, in other words during the molding process one single mold is used to form this part. This presents an advantage as it facilitates the fabrication and assembling process and limits the number of parts needed to be fabricated and assembled. This single molded piece 30 can then be assembled with the tubular container body 2 (shown in FIGS. 7A and 7A) in order to form the tablet dispensing device 1 as illustrated in FIGS. 3A and 3B.

Alternatively or in addition (illustrated in FIGS. 7A and 7B), the tubular container body can comprise a tamper-evident element which may be a removable tab 13a directly blocking the tablet dispensing opening 4 and connected to the part of the tubular side wall 7 surrounding the dispensing opening 4 with frangible elements 13b.

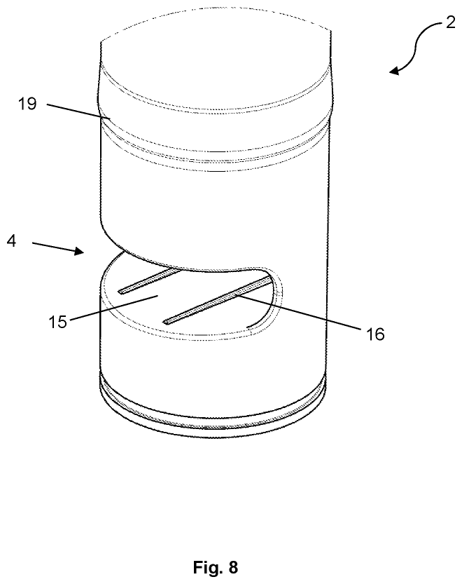

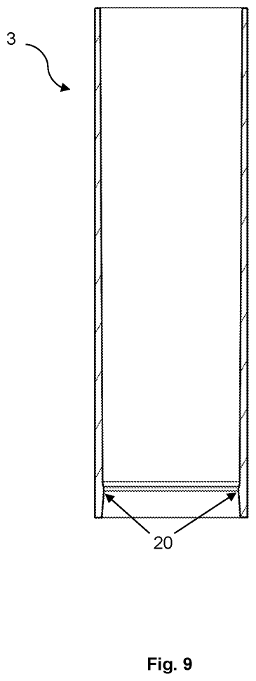

FIGS. 7A, 7B and 8 illustrate a cross sectional view, a perspective view and an enlarged perspective view of the tubular container body 2 respectively. In FIGS. 7A and 7B, the dispensing opening 4 is closed by a removable tab 13a whereas FIG. 8 shows the dispensing opening 4 without removable tab 13a. The tubular container body 2 comprises a tablet dispensing opening 4 formed on the tubular side wall 7. The tablet dispensing opening 4 is flush with a support surface 15 delimiting the internal dispensing space 8. The stack of tablets may be arranged on the support surface 15. More particularly, the tablet which will be dispensed first may be positioned on the support surface 15 and may be in direct communication with the external environment via the tablet dispensing opening 4 (when the sleeve 3 is at the second position). The support surface 15 may present an inclination relative to a plane transverse to the tubular container body. This inclination may be for example from 1° to 6°. This inclination makes it possible to facilitate the distribution of the tablet through the tablet dispensing opening 4. The surface 15 may further present one or more surface ribs 16. The surface ribs 16 may be linear. The surface ribs 16 may be oriented towards the dispensing opening 4. The presence of the surface ribs 16 makes it possible to facilitate the distribution of the tablet by guiding the tablet towards the tablet dispensing opening 4 while at the same time minimizing the contact and the friction between the tablet and the support surface 15. The surface ribs 16 may present an inclination relative to the support surface 15. The tubular container body may further include a hollow space 17, the support surface 15 delimiting the internal dispensing space 8 on one side and the hollow space 17 on the other side. The presence of the hollow space 17 presents an advantage as it facilitates the fabrication process of the tubular container body 2 and makes the molding of the tubular container body 2 more accurate. The hollow space 17 can further be used as a housing for containing an active agent (for example a desiccant).

Optionally, the surface 15 may also be provided with holes (not illustrated in the figures). This feature is advantageous when an active agent is placed in the hollow space 17, and where the presence of holes on the surface 15 allow moisture and/or other gaseous substances to pass from the internal dispensing space 8 through the surface 15 in order to be trapped by the active agent. For example, the active agent may be placed in the chamber 18′ formed in the lower cap 12. Alternatively, the active agent may be placed in the chamber 18 formed in the upper cap 11. Alternatively, the active agent may be placed in the chamber 18′ formed in the lower cap 12, the chamber 18′ being arranged in the hollow space 17 when the cap 12 closes the lower extremity 6 of the tubular container body 2 and in chamber 18 formed in the upper cap 11. This chamber 18 is shown in FIG. 5.

FIGS. 7A, 7B and 8 also illustrate a peripheral sealing rib 19 arranged on the outer surface of the tubular side wall 7. The peripheral sealing rib 19 extends over the entire circumference of the outer surface of the tubular side wall 7 continuously.

FIG. 9 illustrates the sleeve 3 once it has been disconnected from the tamper-evident element 13 (for example by removing the tearable band). A second peripheral sealing rib 20 is present on the inner surface of the sleeve 3, extending over the entire circumference of the inner surface of the sleeve 3 continuously. In fact, when the tubular container body 2 is placed in the sleeve 3, and when the sleeve 3 is at the first position, the tablet dispensing opening 4 is arranged between the two peripheral sealing ribs 19 and 20. The presence of the peripheral sealing ribs 19 and 20 makes it possible to achieve sealing the tablet dispensing opening 4 in an airtight manner.

In the embodiment shown in FIGS. 3 to 9, the sealing rib 19 is located above the dispensing opening 4 whereas the sealing rib 20 is located below the dispensing opening 4 (when the sleeve 3 is in the first -closed- position). Alternatively (not shown in figures), the sealing rib 19 on the tubular side wall 7 may be located below the dispensing opening 4 while the sealing rib 20 on the sleeve 3 may be located above the dispensing opening 4 (when the sleeve 3 is in the closed position).

Alternatively, both sealing ribs 19 and 20 may be on the same part, either on the outer surface of the tubular side wall 7 or on the inner surface of the sleeve 3 (not shown in figures).

The tubular container body 1 may have a length allowing to contain at least 10 tablets, preferably at least 15 tablets.

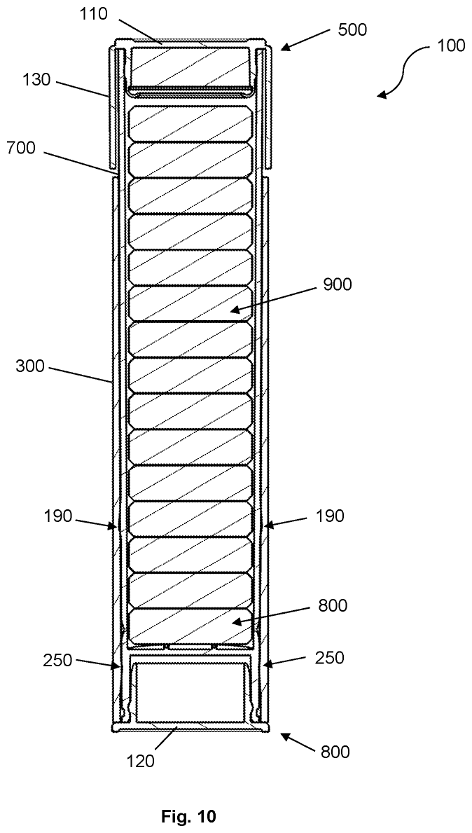

FIGS. 10 to 17 illustrate a second embodiment of a tablet dispensing device 100 according to the first configuration (i.e. wherein the tablet storage space is provided into the tubular container body).

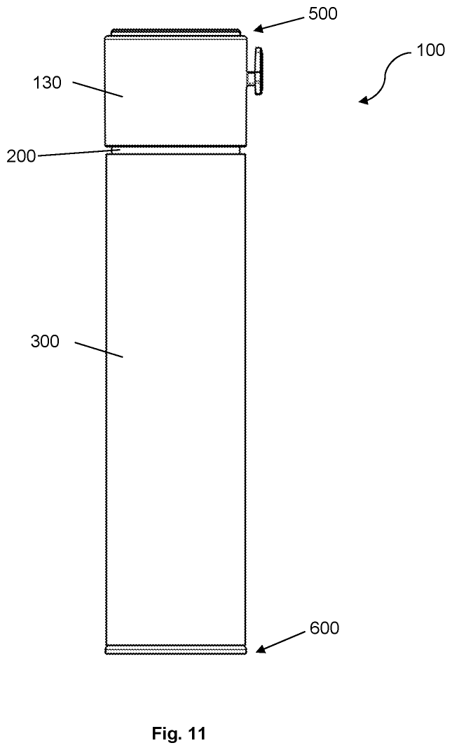

FIG. 10 shows a cross sectional view of the tablet dispensing device 100, and FIG. 11 illustrates a profile view of the tablet dispensing device 100. With reference to FIGS. 10 and 11, the tablet dispensing device 100 comprises a tubular container body 200 and a sleeve 300 arranged on the outer surface of the tubular container body 200.

The tubular container body 200 comprises an upper extremity 500, a lower extremity 600 and a tubular side wall 700 defining an internal dispensing space 800 capable of receiving a stack of tablets. In this example, the tablet dispensing device 100 is according to the first configuration, in other words the tablet storage space 900 is part of the tubular container body 200.

The upper extremity 500 may be sealed with an upper cap 110. The upper cap 110 may be provided with an abutment extending over the entire circumference of the upper cap 110 (for example the overall external diameter of the cap 110 may be bigger than the overall diameter of the upper extremity of the tubular container body in order to form a protrusion beyond the tubular side wall 700 in the radial direction). Alternatively, the abutment may extend over a part of the circumference of the upper cap 110.

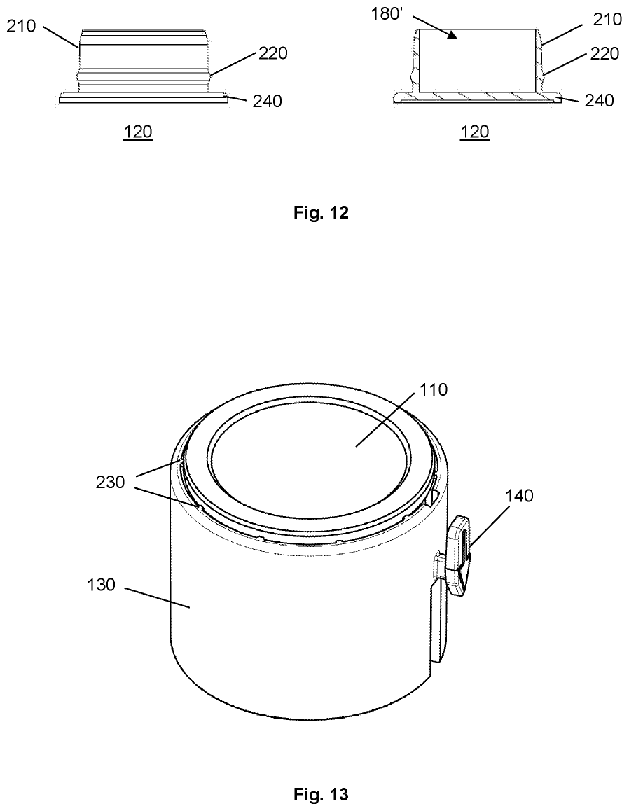

The lower extremity 600 is sealed with a lower cap 120 shown in FIG. 12. FIG. 12 shows a profile view and a cross-sectional view of the lower cap 120. The lower cap 120 may comprise a lateral wall 210 which defines a chamber 180′. One or more protrusions 220 may be disposed on the periphery of the lateral wall 210, in a continuous or a discontinuous way, so that the lower cap 120 may be press-fit in the tubular container body 200. Furthermore, the protrusion 220 can extend over the periphery in a continuous way such as to establish an airtight seal with the tubular container body 200.The lower cap 120 may also be provided with an abutment 240 extending over the entire circumference of the lower cap 120. Alternatively, the abutment may extend over a part of the circumference of the lower cap 120.

Alternatively, the lower extremity 600 may remain unsealed. In this case, the tubular container body 200 may itself be provided with an abutment (not shown in the figures) that can be local or can extend over the entire circumference of the lower extremity 600 of the tubular container body 200.

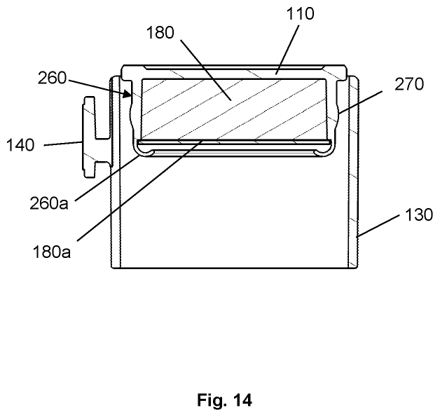

The tablet dispensing device 100 further comprises a tamper-evident element 130 on its upper extremity 500 configured to close the tablet dispensing opening 400 (shown in FIGS. 13 and 14) present on the tubular side wall 700 of the tubular container body 200. The tamper-evident element 130 is arranged adjacent to the upper extremity 500 of the tubular container body 200.

With reference to FIG. 13 which shows a perspective view of the upper cap 110 and the tamper-evident element 130, the tamper-evident element 130 is a tearable band or ring extending over the entire circumference of the tubular side wall 700 and over one portion of the length of the tubular side wall 700. The tamper-evident element 130 is connected to the upper cap 110 by a plurality of frangible elements 230. The tamper-evident element 130 prevents the longitudinal sliding of the sleeve 300 over the tubular side wall 700. The tamper-evident element 130 may also be provided with a seizure member 140 to grip the tamper-evident element 130 and facilitate removal of the tamper-evident element 130. Therefore, before removing the tamper-evident element 130, the movement of the sleeve 300 is blocked by the tamper-evident element 130. In order to use the tablet dispensing device 100 for the first time the tearable band is removed by breaking the frangible elements 230, removing the tamper-evident element 130 so that the sleeve 300 can move longitudinally over the tubular container body 200.

In this case, the upper cap 110 and the tamper-evident element 130 may be integrally formed in a single-molded piece, in other words during the molding procedure one single mold is used to form this part. This presents the advantage of facilitating the fabrication and assembling process and limiting the number of parts needed to be fabricated to form the tablet dispensing device 100. Alternatively, the upper cap 110, the tamper-evident element 130 and the sleeve 300 may be integrally formed in a single-molded piece.

FIG. 14 shows a cross-sectional view of the upper cap 110 and the tamper-evident element 130. The upper cap 110 may comprise a lateral wall 260 which defines a chamber 180. The chamber 180 may be filled with an active agent (preferably a desiccant) and closed by a permeable cardboard 180a that is maintained by crimping the lower end 260a of the lateral wall 260. One or more protrusions 270 may be disposed on the periphery of the lateral wall 260 in a continuous way, so that the upper cap 110 may be press-fit in the tubular container body 200 in an airtight manner. After the tubular container body is filled with the tablets and closed with the cap 110 in an airtight manner, the tablets are preserved from the moisture or oxygen of the environment that is external to the tablet storage space.

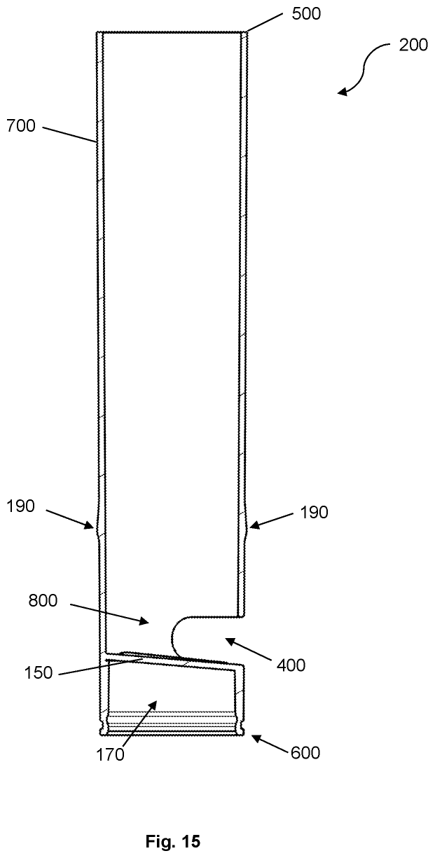

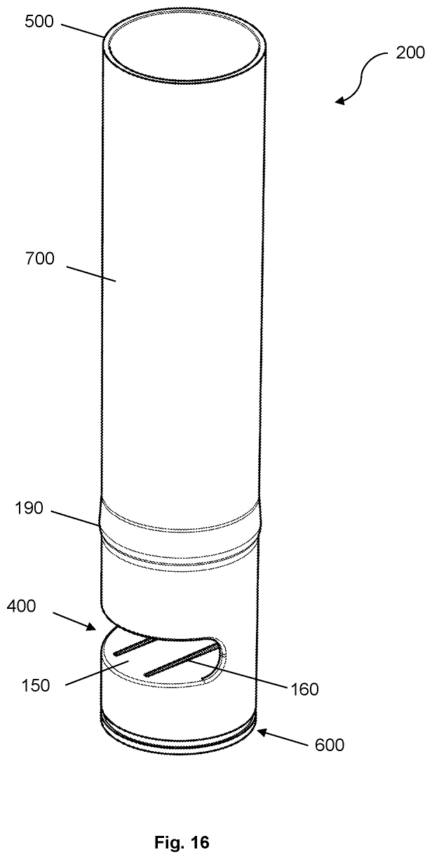

FIGS. 15 and 16 illustrate a cross sectional view and a perspective view of the tubular container body 200 respectively. The tubular container body 200 may comprise no abutment on the upper extremity 500 (in this case, the abutment may be provided by the upper cap 110). The tubular container body 200 comprises a tablet dispensing opening 400 formed on the tubular side wall 700. The tablet dispensing opening 400 is flush with a support surface 150 delimiting the internal dispensing space 800. The stack of tablets may be arranged on the support surface 150. The support surface 150 may present an inclination relative to a plane transverse to the tubular container body 200. This inclination may be for example from 1° to 6°. This inclination makes it possible to facilitate the distribution of the tablet through the tablet dispensing opening 400. The support surface 150 may further present one or more surface ribs 160. The surface ribs 160 may be linear. In addition, the surface ribs 160 may be oriented towards the dispensing opening 400. The presence of the surface ribs 160 make it possible to facilitate the distribution of the tablet by guiding the tablet towards the tablet dispensing opening 400 while at the same time minimizing the contact and the friction between the tablet and the support surface 150. The tubular container body may further include a hollow space 170, the support surface 150 delimiting the internal dispensing space 800 on one side and the hollow space 170 on the other side. The presence of the hollow space 17 presents an advantage as it facilitates the fabrication process of the tubular container body 200 and makes the molding of the tubular container body 200 more accurate. The hollow space can further be used as a housing for containing an active agent (for example a desiccant).

Optionally, the surface 150 may also be provided with holes (not illustrated in the figures). This feature is advantageous when an active agent is placed in the hollow space 170, and where the presence of holes on the surface 150 allow moisture and/or other gaseous substances to pass from the internal dispensing space 800 through the surface 150 in order to be trapped by the active agent. For example, the active agent may be placed in chamber 180′ formed in the lower cap 120, the chamber 180′ being arranged in the hollow space 170 when the cap 120 closes the lower extremity 6 of the tubular container body 200 (shown in FIG. 12). Alternatively, the active agent may be placed in chamber 180 formed in the upper cap 110 (shown in FIG. 14). Alternatively, the active agent may be placed in chamber 180′ formed in the lower cap 120 and in chamber 180 formed in the upper cap 110. In case the surface 150 does not comprise holes, the lower extremity 600 may remain unsealed.

FIGS. 15 and 16 further illustrate a peripheral sealing rib 190 arranged on the outer surface of the tubular side wall 700. The peripheral sealing rib 190 extends over the entire circumference of the outer surface of the tubular side wall 700 continuously.

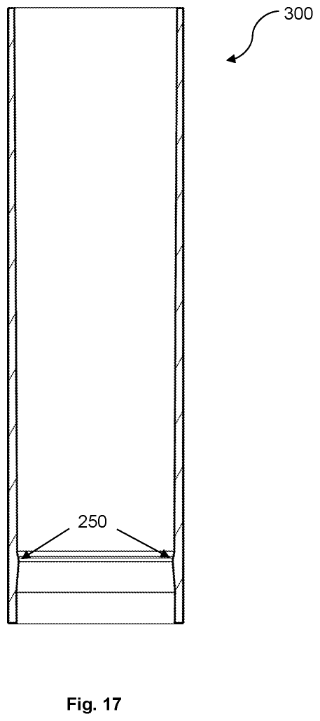

FIG. 17 illustrates a second peripheral sealing rib 250 present on the inner surface of the sleeve 300, extending over the entire circumference of the inner surface of the sleeve 300 continuously. Therefore, when the tubular container body 200 is placed in the sleeve 300, and when the sleeve 300 is in the first position, the tablet dispensing opening 400 is arranged between the two peripheral sealing ribs 190 and 250. The presence of the peripheral sealing ribs 190 and 250 makes it possible to achieve sealing the tablet dispensing opening 400 in an airtight manner.

In this embodiment, the sealing rib 190 is located above the dispensing opening 400 and the sealing rib 250 is located below the dispensing opening 400 (when the sleeve 300 is in the closed position). Alternatively, the sealing rib 190 on the tubular side wall 700 can be located below the dispensing opening 400 and the sealing rib 250 on the sleeve 300 can be located above the dispensing opening 400 (when the sleeve 300 is in the closed position).

Alternatively, both sealing ribs 190 and 250 can be on the same part: either on the outer surface of the tubular side wall 700 or on the inner surface of the sleeve 300.

The tubular container body 100 may have a length allowing to contain at least 10 tablets, preferably at least 15 tablets.

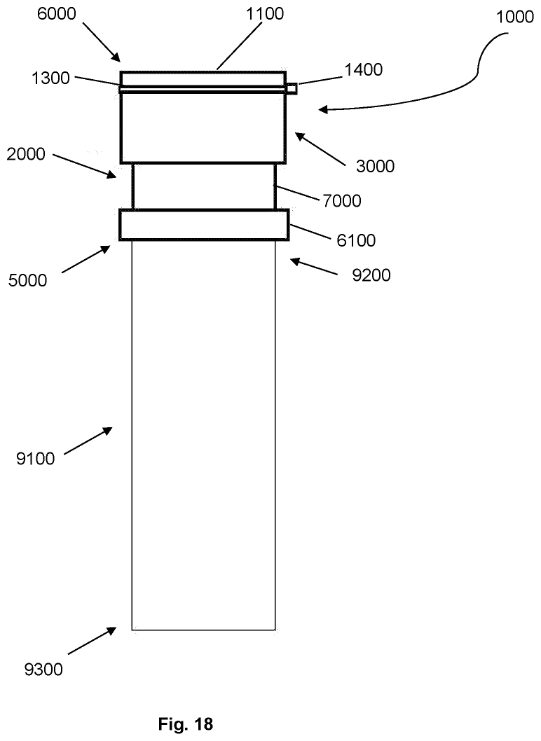

FIGS. 18 to 21 illustrate a third embodiment with a tablet dispensing device 1000 according to the second configuration.

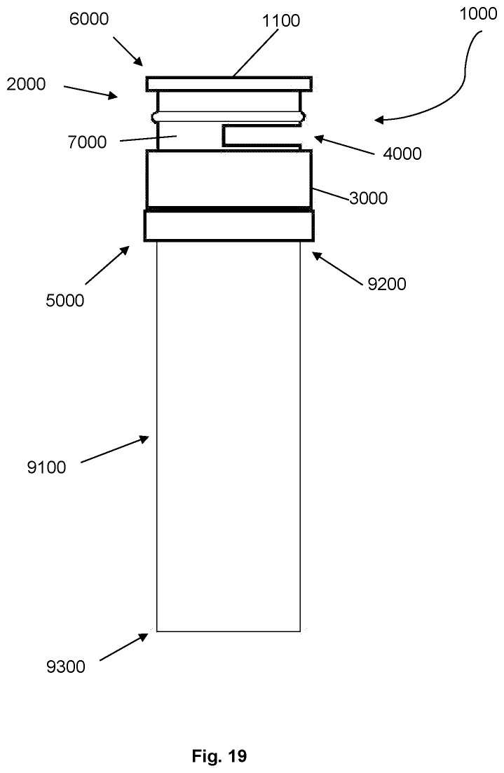

FIGS. 18 and 19 illustrate profile views of the tablet dispensing device 1000, which comprises a tubular container body 2000 and a sleeve 3000. The tubular container body 2000 comprises a tubular side wall 7000 defining an internal dispensing space 8000, and a tablet dispensing opening 4000 formed on the tubular side wall 7000. Furthermore, the tubular container body 2000 comprises an upper extremity 5000 and a lower extremity 6000. In FIG. 18, the sleeve 3000 is at the first position where it covers the tablet dispensing opening 4000, while in FIG. 19 the sleeve 3000 is at the second position where it uncovers the tablet dispensing opening 4000. In this example, the tablet dispensing device 1000 is connected to a tablet storage space 9000 comprising a stack of tablets, which is in communication with the internal dispensing space 8000. The tablet storage space 9000 may be defined by a container 9100 (such as a standard tube available on the market for example) having a lower open extremity 9200 clipped on the upper extremity 5000 of the tubular container body 2000 and an upper closed extremity 9300.

FIG. 18 further illustrates that the tablet dispensing device 1000 may comprise a lower cap 1100, and a tamper-evident element 1300 which, prior to opening the tablet dispensing device 1000 for the first time, connects the sleeve 3000 to the lower cap 1100. The tamper-evident element 1300 may be a tearable band comprising a plurality of frangible elements that connect the sleeve 3000 to the lower cap 1100 in order to prevent the longitudinal sliding of the sleeve 3000 over the tubular side wall 7000. The tamper-evident element 1300 may also be provided with a seizure member 1400 to grip the tamper-evident element 1300 and facilitate removal of the tamper-evident element 1300. Therefore, the lower cap 1100, the tamper-evident element 1300 and the sleeve 3000 may be integrally formed in a single-molded piece, which makes it possible to facilitate the fabrication and assembling process and limit the number of parts needed to be fabricated to form the tablet dispensing device 1000.

FIG. 18 further illustrates a connecting element 6100 present on the upper extremity 5000 of the tubular container body 2000 and configured to be clipped to the lower extremity 9200 of the container 9100. Furthermore, the element 6100 is preferably connected to the container 9100 in an airtight manner in order to limit as much as possible the entry of moisture or oxygen in the internal space of the tubular container body through this connection.

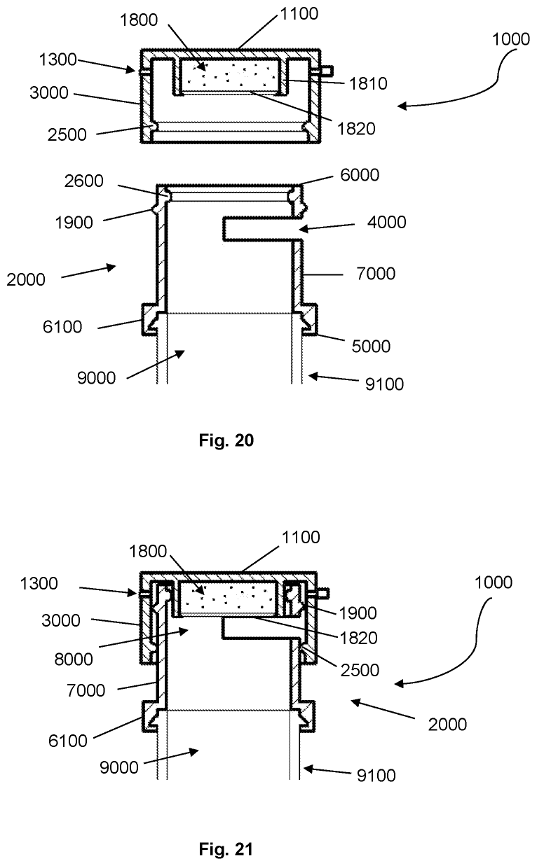

FIGS. 20 and 21 show cross-sectional views of the tablet dispensing device 1000 respectively before and after assembly. FIG. 20 illustrates, on one hand, the tubular container body 2000 connected to the container 9100 by the connecting element 6100, and, on the other hand, the single molded piece comprising the sleeve 3000, the lower cap 1100 and the tamper-evident element 1300, prior to assembling the sleeve 3000 over the tubular container body 2000. FIG. 21 illustrates the same parts of the tablet dispensing device 1000 as the ones shown in FIG. 20, after assembling the part (single molded piece) comprising the sleeve 3000 over the tubular container body 2000.

FIGS. 20 and 21 illustrate cap 1100 comprising a chamber 1800 creating a hollow space, wherein an active agent can be arranged in order to absorb moisture and/or other gaseous substances present in the tablet dispensing device 1000 and the container 9100. Alternatively, chamber 1800 may be empty. Chamber 1800 is defined by a lateral wall 1810 and a support surface 1820 perpendicular to the lateral wall 1810. The support surface 1820 delimits the internal dispensing space 8000 on one side and the chamber 1800 on the other side. In case the chamber 1800 comprises an active agent, the support surface 1820 is preferably permeable to moisture and/or oxygen so that the active agent may trap such gaseous substances present in the internal dispensing space 8000 and the tablet storage space 9000. In case the chamber 1800 does not comprise an active agent, this surface may be devoid of holes.

Alternatively, instead of the support surface 1820 on the cap 1100, a support surface can be provided by a transverse wall integrally formed with the tubular side wall 7000.

As illustrated in FIG. 21, after the tablet dispensing device 1000 is assembled, the surface 1820 may be used to support the stack of tablets, when the tablet dispensing device 1000 is turned upside down, in other words when the container 9100 is connected on top of the tubular container body 2000 and not below. Therefore, in order to facilitate the tablet distribution, the surface 1820 may present an inclination relative to a plane transverse to the tubular container body. This inclination may be for example from 1° to 6°. Furthermore, for the same reasons as detailed above, the surface 1820 may further present one or more surface ribs (not shown in the figures).

FIGS. 20 and 21 further illustrate a peripheral sealing rib 1900 which may be present on the outer surface of the tubular container body 2000, and a second peripheral rib 2500 which may be present on the inner surface of the sleeve 3000. When the sleeve 3000 is at the second position, covering the tablet dispensing opening 4000 (FIG. 21), the tablet dispensing opening 4000 is arranged between the two peripheral sealing ribs 1900, 2500 so that the tablet dispensing opening 4000 is sealed in an airtight manner. Furthermore, a sealing element 2600 (for example a rib) which may extend over the entire circumference of the lower extremity 6000 on the inner surface of the tubular container body 2000, makes it possible to press-fit the cap 1100 to the tubular container body 2000 and close in an air-tight manner the lower extremity 6000 of the tubular container body 2000.

In this embodiment, the sealing rib 1900 is located below the dispensing opening 4000 and the sealing rib 2500 is located above the dispensing opening 4000 (when the sleeve 3000 is in the closed position). Alternatively, the sealing rib 1900 on the tubular side wall 7000 can be located above the dispensing opening 4000 and the sealing rib 2500 on the sleeve 3000 can be located below the dispensing opening 4000 (when the sleeve 3000 is in the closed position).

Alternatively, both sealing ribs 1900 and 2500 can be on the same part: either on the outer surface of the tubular side wall 7000 or on the inner surface of the sleeve 3000.

The tubular container body 1000 may have a length allowing to contain 2 to 5 tablets, preferably 2 or 3 tablets.

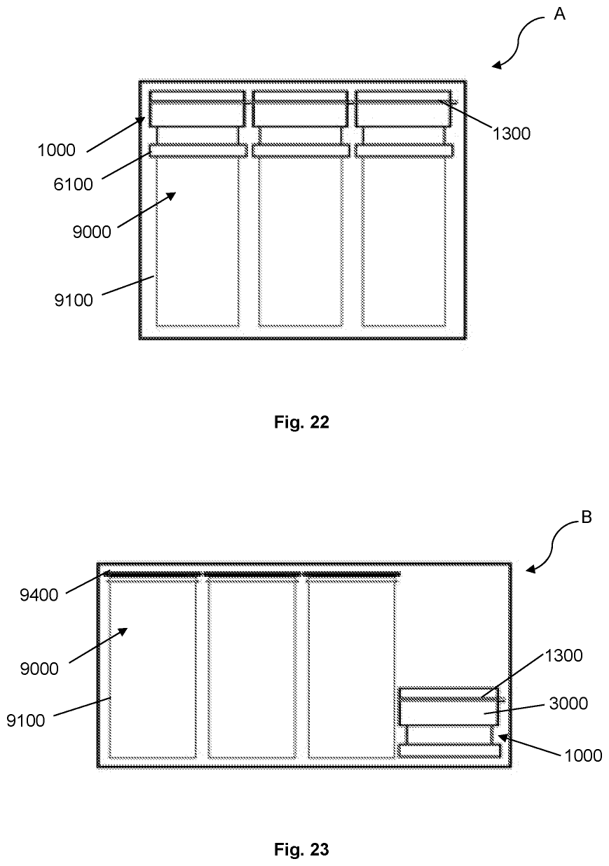

Examples of different kits comprising one or more tablet dispensing devices 1000 will be described with reference to FIGS. 22 and 23.

FIG. 22 shows a kit A comprising several tablet dispensing devices 1000, each one of them connected to a container (such as a standard tube) 9100, by the connecting element 6100. Each of the tablet dispensing devices 1000 may comprise a tamper-evident element 1300. The tamper-evident element 1300 can be removed, to release the sleeve 3000 and allow the tablet distribution. When no more tablets remain in the tablet storage space 9000, the user may throw away the tablet dispensing device 1000 connected to the empty container 9100, and use a new tablet dispensing device 1000 connected to a container 9100 comprising a stack of tablets.

Kit A may further comprise a package wherein the several tablet dispensing devices 1000 are stored. This package may be made from plastic, cardboard, aluminum foil or other material.

FIG. 23 shows a kit B comprising one tablet dispensing device 1000, and more than one containers (such as a tube) 9100, each container 9100 being configured to be connected to the tablet dispensing device 1000, by the connecting element 6100 present on the tablet dispensing device 1000. In addition, each container 9100, and more particularly the lower extremity 9200 of each container 9100 may be provided with an aluminum film 9400 which seals in an airtight manner the container 9100 prior to its connection to the tablet dispensing device 1000, in order to protect the tablets from external atmosphere (moisture). The tablet dispensing device 1000 may also comprise a tamper-evident element 1300. The aluminum film 9400 may be removed in order to assemble one of the containers 9100 to the tablet dispensing device 1000. After assembling the container 9100 to the tablet dispensing device 1000, the tamper-evident element 1300 can be removed, to release the sleeve 3000 and allow the tablet distribution. When no more tablets remain in the tablet storage space 9000 of the container 9100, the container 9100 may be detached from the tablet dispensing device 1000 and replaced with a new container 9100 filled with a stack of tablets. Kit B may further comprise a package wherein the tablet dispensing device 1000 and the containers 9100 are stored. This package may be made from plastic, cardboard or other material.

The tablet dispensing devices 1, 100, 1000 as well as the kits A, B may be used for the distribution of pharmaceutical, nutraceutical, veterinary and/or agro-alimentary products. Such products may be for example, effervescent or non-effervescent tablets, capsules, granules, powders, food supplements such as vitamins or minerals.

The present invention further relates to a method for manufacturing the tablet dispensing device 1, 100, 1000. The method comprises the manufacture of the tubular container body 2, 200, 2000 by thermoplastic injection molding. The tubular container body 2, 200, 2000 may be a single-molded piece. The method also comprises the manufacture of the sleeve 3, 300, 3000 by thermoplastic injection molding. The sleeve 3, 300, 3000 may be formed as a single molded piece with the tamper-evident element 13, 130, 1300 and a cap (upper cap 11, 110, 1100 or lower cap 12, 120, 1200). Alternatively, the sleeve 3, 300, 3000 may represent a single piece on its own, while the method may further comprise manufacturing by thermoplastic injection molding the tamper-evident element 13, 130, 1300 and a cap (upper cap 11, 110, 1100 or lower cap 12, 120, 1200) as a single-molded piece.

The method may comprise assembling said parts together, along with other additional parts as described above, in an easy manner, just by assembling the single molded piece comprising the sleeve 3, 300, 3000 over the tubular container body 2, 200, 2000 and press-fitting the cap(s) (upper cap 11, 110 or lower cap 12, 120, 1100) to the tubular container body 2, 200, 2000, without welding the different parts together. When the tablet dispensing device is according to the first configuration, the method may also comprise filling the tubular container body 2, 200 with a stack of tablets, prior to its assembly with the cap(s) (upper cap 11, 110 or lower cap 12, 120) and/or with other additional parts as described above. Alternatively, when the tablet dispensing device is according to the second configuration, both parts (sleeve 3000 and tubular container body 2000) can be assembled independently of the filling process (in order to get the dispensing device 1000). The container 9100 may be filled with tablets and then sealed with an aluminum film 9400. The method for conditioning the tablet dispensing device according to the second configuration may further comprise placing an aluminum film 9400 on the open extremity of the container 9100. Then, when used, the container 9100 may be assembled, after removal of the aluminum foil, to the tablet dispensing device 1000. Alternatively, no aluminum film is placed on the open extremity of the container 9100, as the container 9100 may be directly connected to the tablet dispensing device 1000.

1. A tablet dispensing device, comprising:
a tubular container body including two extremities, a tubular side wall in between, the tubular side wall defining an internal dispensing space capable of receiving a tablet to be dispensed, and a tablet dispensing opening formed on the tubular side wall;
a sleeve configured to slide longitudinally over the tubular side wall and between the two extremities, between a first position, in which the sleeve covers in an airtight manner the tablet dispensing opening, and a second position, in which the sleeve uncovers the tablet dispensing opening,
wherein the tablet dispensing device comprises at least two peripheral sealing ribs arranged on an outer surface of the tubular side wall and/or on an inner surface of the sleeve, the tablet dispensing opening being between the two peripheral sealing ribs when the sleeve is at the first position.

2. The tablet dispensing device according to claim 1, wherein at least one sealing rib is arranged on the outer surface of the tubular side wall and at least one sealing rib is arranged on the inner surface of the sleeve.

3. The tablet dispensing device according to claim 1, claim 2, wherein the two extremities of the tubular container body are provided with an abutment that prevents the sleeve from moving beyond the tubular sidewall of the tubular container body.

4. The tablet dispensing device according to claim 1, wherein the sleeve comprises a tubular side wall and two extremities, and wherein the two extremities are open.

5. The tablet dispensing device according to claim 1, comprising a tamper-evident element.

6. The tablet dispensing device according to claim 5, wherein the tamper-evident element prevents longitudinal sliding of the sleeve over the tubular side wall, or wherein the tamper-evident mechanism is a removable tab blocking the tablet dispensing opening.

7. The tablet dispensing device according to claim 5, wherein the tamper-evident element, the sleeve and, optionally, a cap for closing one of the two extremities of the tubular container body, are integrally formed in a single molded piece.

8. The tablet dispensing device according to claim 5, wherein the tamper-evident element, and a cap for closing one of the two extremities of the tubular container body are integrally formed in a single molded piece.

9. The tablet dispensing device according to claim 7, wherein the cap is press-fit into the tubular container body.

10. The tablet dispensing device according to claim 1, further comprising at least one active agent in fluid communication with the internal dispensing space.

11. The tablet dispensing device according to claim 10, wherein the active agent is arranged in a cap closing a respective one of the two extremities of the tubular container body.

12. The tablet dispensing device according to claim 1, wherein the tablet dispensing opening is flush with a support surface delimiting the internal dispensing space, the support surface being optionally inclined relative to a plane transverse to the tubular container body, the inclination of the support surface relative to the plane transverse to the tubular container body having a value with a range from 1° to 30°.

13. The tablet dispensing device according to claim 12, wherein the tubular container body further includes a hollow space, the support surface delimiting the internal dispensing space on one side and the hollow space on another side.

14. The tablet dispensing device according to claim 12, wherein the support surface comprises one or more surface ribs oriented towards the tablet dispensing opening.

15. The tablet dispensing device of claim 1, wherein the tubular container body and the sleeve are made of different materials.

16. The tablet dispensing device according to claim 1, wherein the tubular container body comprises a tablet storage space in communication with the internal dispensing space.

17. The tablet dispensing device according to claim 1, wherein the tubular container body is connected to a container having a tablet storage space, the tablet storage space being in communication with the internal dispensing space.

18. A kit comprising:
one or more tubes each including two closed ends, defining a tablet storage space containing tablets and configured to be opened at one respective end; and
a tablet dispensing device configured to be assembled to the respective open end of each tube, the tablet dispensing device comprising:
a tubular container body including two extremities, a tubular side wall in between, the tubular side wall defining an internal dispensing space capable of receiving a tablet to be dispensed, and a tablet dispensing opening formed on the tubular side wall;
a sleeve configured to slide longitudinally over the tubular side wall and between the two extremities, between a first position, in which the sleeve covers in an airtight manner the tablet dispensing opening, and a second position, in which the sleeve uncovers the tablet dispensing opening,
wherein the tablet dispensing device comprises at least two peripheral sealing ribs arranged on an outer surface of the tubular side wall and/or on an inner surface of the sleeve, the tablet dispensing opening being between the two peripheral sealing ribs when the sleeve is at the first position.

19. (canceled)

20. A method of distributing pharmaceutical, nutraceutical, veterinary and/or agro-alimentary products, comprising:
providing a tablet dispensing device that comprises:
a tubular container body including two extremities, a tubular side wall in between, the tubular side wall defining an internal dispensing space capable of receiving a tablet to be dispensed, and a tablet dispensing opening formed on the tubular side wall;
a sleeve configured to slide longitudinally over the tubular side wall and between the two extremities, between a first position, in which the sleeve covers in an airtight manner the tablet dispensing opening, and a second position, in which the sleeve uncovers the tablet dispensing opening,
wherein the tablet dispensing device comprises at least two peripheral sealing ribs arranged on an outer surface of the tubular side wall and/or on an inner surface of the sleeve, the tablet dispensing opening being between the two peripheral sealing ribs when the sleeve is at the first position; and
dispensing at least one tablet from the tablet dispensing device.

21. A method of distributing pharmaceutical, nutraceutical, veterinary and/or agro-alimentary products, comprising:
providing a kit that comprises:
one or more tubes each including two closed ends, defining a tablet storage space containing tablets and configured to be opened at one respective end; and
a tablet dispensing device configured to be assembled to the respective open end of each tube, the tablet dispensing device comprising:
a tubular container body including two extremities, a tubular side wall in between, the tubular side wall defining an internal dispensing space capable of receiving a tablet to be dispensed, and a tablet dispensing opening formed on the tubular side wall;
a sleeve configured to slide longitudinally over the tubular side wall and between the two extremities, between a first position, in which the sleeve covers in an airtight manner the tablet dispensing opening, and a second position, in which the sleeve uncovers the tablet dispensing opening,
wherein the tablet dispensing device comprises at least two peripheral sealing ribs arranged on an outer surface of the tubular side wall and/or on an inner surface of the sleeve, the tablet dispensing opening being between the two peripheral sealing ribs when the sleeve is at the first position; and
dispensing at least one tablet from the tablet dispensing device.
